(19) United States
(12) Patent Application Publication
(10) Pub. No.: US 2025/0337502 A1
(43) Pub. Date: Oct. 30, 2025

(54) A COMMUNICATIONS DEVICE

(71) Applicant: HERIOT-WATT UNIVERSITY, Edinburgh (GB)

(72) Inventors: Ross DONALDSON, Edinburgh (GB); David CANNING, Edinburgh (GB); Robert THOMSON, Edinburgh (GB); Gerald BULLER, Edinburgh (GB)

(21) Appl. No.: 18/864,875

(22) PCT Filed: May 12, 2023
(86) PCT No.: PCT/GB2023/051261

§ 371 Date: Nov. 11, 2024

(30) Foreign Application Priority Data
May 12, 2022 (GB) 2206978.5

(51) Int. Cl. H04B 10/70; G02B 6/28

(52) U.S. Cl. CPC H04B 10/70; G02B 6/2861

(57) ABSTRACT

A quantum communications device element comprising: a receiver configured to: receive a quantum input signal in a statistical mixture comprising a pre-determined set of quantum states; probabilistically determine the quantum states of the predetermined set of quantum states of the quantum input signal; and output input signals corresponding to the quantum states of the quantum input signal; a coupling device coupled to the receiver, said coupling device being configured to convert the input signals to an output signal by time-division multiplexing the input signals; and a detector coupled to the coupling device, the detector being configured to receive the output signal.

### TECHNICAL FIELD

The present invention relates to a device element for communications. In particular, the device element of the present invention finds particular use in quantum communications.

### BACKGROUND

Quantum communication is a communication method which implements a communication protocol involving components of quantum mechanics. Quantum communication finds particular use in, for example, quantum key distribution (QKD), which is a secure communication method which implements a cryptographic protocol. Quantum communication is implemented via, for example, light signals comprising photons having a particular polarization.

Light signals in quantum communication protocols are of the single-photon level. Therefore, expensive single-photon detectors are required to receive the light signals. Additionally, communication protocols tend to require multiple single-photon detectors, each requiring sophisticated thermal cooling units. Accordingly, a cost of the already expensive single-photon detectors is multiplied. Similarly expensive high-quality multi-channel timing electronics are also required to facilitate the quantum communication protocol.

In addition to a high monetary cost, the single-photon detectors, thermal cooling units, and multi-channel timing electronics also add to size, weight, and power (SWaP) requirements.

The present invention has been devised to mitigate or overcome at least some of the above-mentioned problems.

### SUMMARY OF THE INVENTION

In accordance with a first aspect of the present invention, there is provided a quantum communications device element comprising: a receiver configured to: receive a quantum input signal in a statistical mixture comprising a pre-determined set of quantum states; probabilistically determine the quantum states of the pre-determined set of quantum states of the quantum input signal; and output input signals corresponding to the quantum states of the quantum input signal; a coupling device coupled to the receiver, said coupling device being configured to convert the input signals to an output signal by time-division multiplexing the input signals; and a detector coupled to the coupling device, the detector being configured to receive the output signal.

The pre-determined set of quantum states may be generated and transmitted by a quantum communication device configured to transmit quantum information.

The detector may be a single pixel detector. Alternatively, the detector may be a multi-pixel detector.

The present invention may provide a quantum communications device element which combines and time-division multiplexes one or more input signals into one or more output signals. Advantageously, the present invention may provide a device which requires fewer detectors to facilitate a quantum communications protocol than known quantum communication devices that require, for example, single-photon sensitivity. The present invention may further advantageously provide a device which enables greater optical throughput than conventional optical beam-splitter style couplers.

The present invention is a passive optical device which may be manufactured from, for example, single or multimode fibres. Advantageously, the device may require no input power to function, thereby reducing a power requirement of the device. Further advantageously, the device may be easily manufactured using known methods.

The skilled person will appreciate that the present invention is not limited to quantum communication.

The receiver may be any receiver suitable for quantum communication. For example, the receiver may be a photodetector.

Advantageously, the present invention provides a device, which may reduce a number of detectors required for a quantum communications protocol. In turn, the present invention may also advantageously provide a device for facilitating quantum communication with reduced size, weight, and power requirements.

The receiver preferably comprises a state discrimination device configured to determine the quantum states of the quantum input signal. The skilled person will understand the term “state discrimination device” to mean a device configured to probabilistically determine a quantum state of the quantum input signal. The skilled person will appreciate that the state discrimination device is dependent on the quantum communications protocol of the quantum input signal. For example, a Bennett-Brassard 1984 (BB84) protocol may require a state-discrimination device having a 50:50 beam-splitter, a first polarizing beam-splitter, a second polarizing beam-splitter, and a half-wave plate.

The coupling device may be a waveguide device comprising a plurality of input waveguides in communication with an output waveguide, and a transition region along which the waveguide changes from the plurality of input waveguides to the output waveguide. For example, the waveguide device may comprise optical fibres. The coupling device is preferably a photonic lantern device in a reverse configuration. The skilled person will appreciate that the waveguide device may be any device suitable for propagating and coupling a signal, such as an optical signal, along an axis from the plurality of input waveguides to the output waveguide. The coupling device may differ from known beam-splitter devices because it couples light in a way that can be lossless in both forward and reverse configurations by combining multiple waveguides to a single waveguide which can support at least as many spatial light modes as all of the input waveguides combined.

Preferably, the number of input waveguides is greater than or equal to a number of detectors required for a quantum communications protocol. Advantageously, the device may fully capture information of the quantum input signal.

The transition region of the coupling is preferably configured to adiabatically couple the input signal with the output signal. Preferably, the change from the plurality of input waveguides to the output waveguide transition region is gradual enough that the input signals are adiabatically coupled with the output signal. Advantageously, a loss of signal along the coupling device may be reduced.

Preferably, each of the input waveguides comprises a different waveguide length. Further preferably, the respective waveguide lengths are configured to produce a temporal separation between each of the respective input signals. Further preferably, the temporal separation is greater than a timing-jitter of the detector and less than an input temporal separation of the input signal. Advantageously, a temporal separation greater than the timing-jitter may enable each temporal state to be distinguished correctly. The longest temporal separation of the temporal separations implemented by the input waveguides is preferably less than the input temporal separation in order to keep the output signals in a block, preferably avoiding overlap with a subsequent block.

In some embodiments, the input waveguides are single-mode waveguides. Preferably, single-mode waveguides are applicable for implementation utilising optical fibre channels or adaptive optics in free-space. In alternative embodiments, the input waveguides are multi-mode waveguides. Preferably, multi-mode waveguides are utilised in free-space implementations where there are no or limited adaptive optics.

In some embodiments, the receiver is configured to receive polarisation encoded optical signals. However, the skilled person will appreciate that the receiver may be configured to receive any encoded optical signal suitable for quantum communication, such as phase, time-bin, wavelength, spatial-mode, or angular orbital momentum state.

Preferably, a core diameter of the output waveguide is greater than or equal to a core diameter of each of the input waveguides. In this way, the input waveguides may be more easily coupled with the output waveguide.

Preferably, the input signal is distributed across a first number of spatial modes; the output signal is distributed across a second number of spatial modes; and a sum of the first number of spatial modes is less than the second number of spatial modes. In this way, the output waveguide may accommodate the input signals.

The detector may be a single-photon detector. For example, the single-photon detector may be a single-photon avalanche diode. The skilled person will appreciate that the single-photon detector may be any detector suitable for detecting a single-photon at a time, such as a pixelated single-photon detector. In this way, the detector may be suitable for use with quantum communications.

The input and output optical waveguides may be one or more selected from the range of: one or more optical fibres; and one or more waveguides.

In accordance with a second aspect of the present invention, there is provided a method for routing a plurality of signals to a detector, the method comprising: receiving, at a receiver, a quantum input signal; probabilistically determining, by a state discrimination device element of the receiver, the quantum states of the quantum input signal; outputting, by the receiver, input signals corresponding to the quantum states of the quantum input signal; converting, using a coupling device coupled to the receiver, the input signals to an output signal by time-division multiplexing the input signals; and receiving, at a detector coupled to the coupling device, the output signal from the coupling device.

Preferably, the plurality of signals are coupled to the output fibre by applying a delay to each of the input signals at each of the corresponding input fibres, wherein each delay is unique.

Preferably, the delay is implemented by a fibre length of each of the plurality of input fibres.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

One or more embodiments of the invention will now be described, by way of example only, with reference to the accompanying drawings, in which:

FIG. 1 is a schematic view of a quantum communications device element according to a first aspect of the present invention; and

FIG. 2 is a schematic view of a coupling device element of the quantum communications device element of FIG. 1 according to the present invention; and

FIG. 3 is a method for routing a plurality of signals to a detector using the quantum communications device element of FIG. 1.

### DETAILED DESCRIPTION

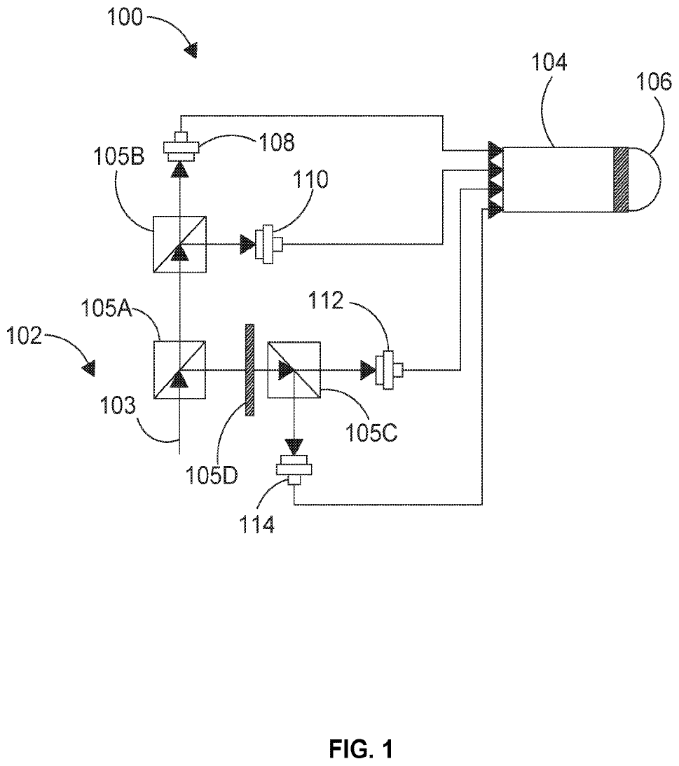

FIG. 1 is a schematic view of a quantum communications device element 100 suitable for facilitating a quantum communications protocol. In the present example, the quantum communications device element 100 is suitable for use with the known Bennett-Brassard 1984 (BB84) protocol.

The quantum communications device element 100 comprises a receiver 102; a coupling device 104; and a detector 106. The receiver 102 is in communication with the coupling device 104. In the present example, the receiver 102 is in optical communication with the coupling device 104. The detector 106 is also in communication with the coupling device 104. In the present example, the detector 106 is in optical communication with the coupling device 104.

The receiver 102 comprises: an optical receiving means 103; and a state discrimination device 105. In the present example, the optical receiving means 103 is an optical fibre.

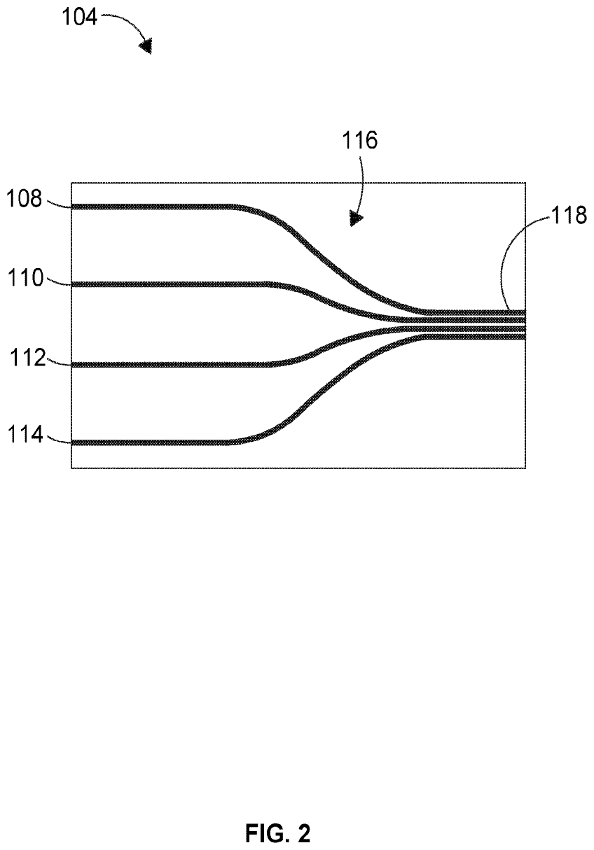

The coupling device 104 is depicted in FIG. 2. The coupling device 104 is a waveguide device comprising a plurality of input waveguides; a transition region 116; and an output waveguide 118.

In the present example, the plurality of input waveguides consist of a first optical fibre 108; a second optical fibre 110; a third optical fibre 112; and a fourth optical fibre 114. The skilled person will appreciate that the plurality of input waveguides must comprise at least as many input waveguides as detectors required for the target quantum communications protocol using known techniques. In the present example, the BB84 protocol requires four detectors using known techniques.

The optical fibres 108, 110, 112, 114 comprise single-mode cores, each having a respective core diameter. In the present example, the core diameter of each single-mode core is 5 μm.

In the present example, the output waveguide 118 is an output optical fibre 118. The output optical fibre 118 comprises a multi-mode core having a core diameter. The core diameter of the multi-mode core is greater than the core diameter of each of the single-mode cores. In the present example, the core diameter of the multi-mode core is 10 μm.

The skilled person will appreciate that the optical fibres 108, 110, 112, 114 may also comprise multi-mode cores, as long as the multi-mode cores support fewer modes than the multi-mode core of the output optical fibre 118. In this example, a sum of the core diameters of each multi-mode optical fibre core is less than a core diameter of the multi-mode core.

The transition region 118 is a region in which the optical fibres 108, 110, 112, 114 transition to the output optical fibre 118. In particular, the coupling device 104 changes smoothly from the optical fibres 108, 110, 112, 114 to the output optical fibre 118. In this way, light propagating along the coupling device 104 will follow the transition and the input signal is adiabatically coupled to the output signal.

To achieve the transition, the optical fibres 108, 110, 112, 114 are fused together to form a unified body, and a cross sectional scale of the unified body is reduced to form the output optical fibre 118.

In the present example, the detector 106 is a single-photon detector 106. In particular, the detector 106 is a single-photon avalanche diode 106.

The optical receiving means 103 of the receiver 102 is configured to receive an input signal, such as a quantum input signal, from an external source (not shown). The quantum input signal comprises quantum information. The quantum information may be represented as a series of qubits of non-orthogonal quantum states that must be determined probabilistically. The series of qubits may be received at a source frequency. For example, the quantum information may be encoded as a series of qubits encoded as polarization encoded photons. In particular, the quantum information may be encoded in a rectilinear basis (i.e. horizontal and vertical polarization) and a diagonal basis (i.e. 45° and 135° polarization).

The state discrimination device 105 according to the present example comprises a 50:50 beam-splitter 105A; a first polarizing beam-splitter 105B; a second polarizing beam-splitter 105C; a half-wave plate 105D. The state discrimination device 105 is in optical communication with the first optical fibre 108; the second optical fibre 110; the third optical fibre 112; and the fourth optical fibre 114.

The state discrimination device 105 is arranged such that an incoming photon passes through the 50:50 beam-splitter 105A. If the photon is reflected by the 50:50 beam-splitter 105A, the first polarizing beam-splitter 105B directs the photon to the first optical fibre 108 or the second optical fibre 110 depending on the polarization of the photon. If the photon is transmitted by the 50:50 beam-splitter 105A, the photon passes through the half-wave plate 105D and the second polarizing beam-splitter 105C directs the photon to the third optical fibre 112 or the fourth optical fibre 114.

For example, if the incoming photon is a vertically polarized photon reflected by the 50:50 beam-splitter 105A, the photon is received by the first optical fibre 108. If the incoming photon is a vertically polarized photon transmitted by the 50:50 beam-splitter 105A, the photon is received by the third optical fibre 112 or the fourth optical fibre 114 with equal probability.

The optical fibres 108, 110, 112, 114 are each configured to cause a respective photon to arrive at the transition region 116 or output waveguide 118 at a respective time. In particular, the first optical fibre 108 is configured to transmit a photon to the transition region 116 at a first time t₁. The second optical fibre 110 is configured to transmit a photon to the transition region 116 at a second time t₂. The third optical fibre 112 is configured to transmit a photon to the transition region 116 at a third time t₃. The fourth optical fibre 114 is configured to transmit a photon to the transition region 116 at a fourth time t₄. In the present example, the respective times are implemented by a difference in optical fibre length of each of the optical fibres 108, 110, 112, 114.

In the present example, the times t₁, t₂, t₃, t₄ are separated by a time-of-arrival spacing value Δt. Accordingly, the first time t₁ is t₁, the second time t₂ is t₁+Δt, the third time t₃ is t₁+2Δt, and the fourth time t₄ is t₁+2Δt.

The optical fibres 108, 110, 112, 114 are arranged such that the time-of-arrival spacing value Δt is greater than a timing-jitter of the single-photon detector 106 and less than an input temporal separation of the quantum input signal corresponding the source frequency. For example, if the input temporal separation is 50 ns, the time-of-arrival spacing value Δt may be 12.5 ns. Alternatively, the time-of-arrival spacing value Δt may be 500 ps. Alternatively, the time-of-arrival spacing value Δt may be asymmetric. In particular, the time-of-arrival spacing value Δt may be 1 ns for the second optical fibre 110, 5 ns for the third optical fibre 112, and 32 ns for the fourth optical fibre 114.

Incoming photons of the quantum input signal are therefore routed to the transition region 116 or output waveguide 118 at different timings dependent on the quantum state of the incoming photon.

The output waveguide 118 is configured to transmit an output signal comprising the incoming photons arranged according to their quantum state to the single-photon detector 106.

The quantum information of the quantum input signal is deducible from the output signal according to the time of arrival of the incoming photons.

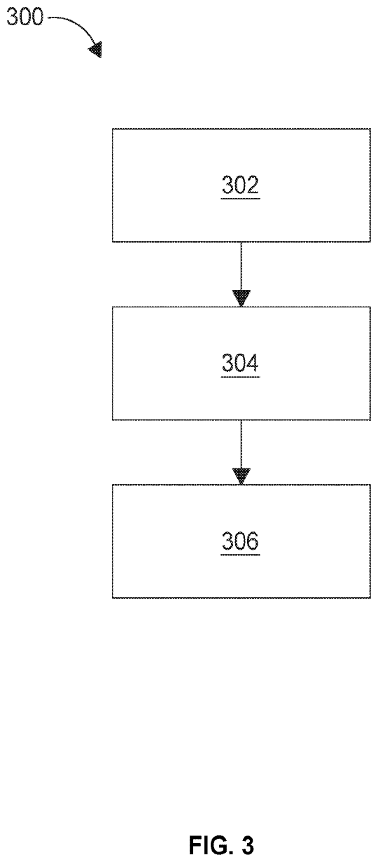

In use, and with reference to the signal routing method 300 of FIG. 3, a quantum input signal comprising quantum information is transmitted from an external source to the quantum communications device element 100. The quantum information comprises a plurality of signals. In the present example, the plurality of signals are encoded as a series of qubits encoded as polarization encoded photons according to a selected basis. For example, the plurality of signals may comprise a first qubit, a second qubit, and a third qubit. The first qubit may have vertical polarization, the second cubit may have horizontal polarization, and the third photon may have 45° polarization.

In a first step 302, the receiver 102 receives the plurality of signals of the quantum input signal via the optical receiving means 103.

In a second step 304, the coupling device 104 couples the plurality of signals to the output optical fibre 118.

In particular, if the first qubit is reflected by the 50:50 beam-splitter 105A, it will be directed to the first optical fibre 108 by the first polarizing beam-splitter 105B. If the second qubit is transmitted by the 50:50 beam-splitter 105A, it will pass through the half-wave plate 105D, and directed to either the third optical fibre 112 or the fourth optical fibre 114 by the second polarizing beam-splitter 105C with equal probability. If the third qubit is transmitted by the 50:50 beam-splitter 105A, it will pass through the half-wave plate 105D, and be directed to the third optical fibre 112.

The first qubit is transmitted to the output optical fibre 118 by the first optical fibre 108 at a time t₁. The second qubit is transmitted to the output optical fibre 118 by the third optical fibre 112 or the fourth optical fibre 114 at a time t₁+2Δt or t₁+3Δt, respectively. The third qubit is transmitted to the output optical fibre 118 by the third optical fibre 112 at a time t₁+2Δt.

In a third step 306, the detector 106 receives the output signal from the output optical fibre 118. In particular, the detector 106 receives the first qubit, the second qubit, and the third qubit at times t₁, t₁+2Δt, and t₁+3Δt respectively.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this invention.

Reference has been made in detail to various implementations, examples of which are illustrated in the accompanying drawings and figures. In the detailed description, numerous specific details are set forth to provide a thorough understanding of the invention provided herein. However, the invention provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the invention provided herein is for the purpose of describing particular implementations and is not intended to limit the invention provided herein. As used in the description of the invention provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

While the foregoing is directed to implementations of various techniques described herein, other and further implementations may be devised in accordance with the invention herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A quantum communications device element comprising:
a receiver configured to:
receive a quantum input signal in a statistical mixture comprising a pre-determined set of quantum states;
probabilistically determine the quantum states of the predetermined set of quantum states of the quantum input signal; and
output input signals corresponding to the quantum states of the quantum input signal;
a coupling device coupled to the receiver, said coupling device being configured to convert the input signals to an output signal by time-division multiplexing the input signals; and
a detector coupled to the coupling device, the detector being configured to receive the output signal
wherein the coupling device is a waveguide device comprising a plurality of input waveguides in communication with an output waveguide, and a transition region along which the waveguide changes from the plurality of input waveguides to the output waveguide, wherein the transition region is configured to couple the input signals with the output signal.

2. The device element of claim 1, wherein the receiver comprises a state discrimination device configured to determine the quantum states of the quantum input signal.

3. The device element of claim 1, wherein the number of input waveguides is greater than or equal to a number of detectors required for a quantum communications protocol.

4. The device element of claim 1, wherein the transition region is configured to adiabatically couple the input signal with the output signal.

5. The device element of claim 1, wherein each of the input waveguides comprise a different waveguide length.

6. The device element of claim 5, wherein the respective waveguide lengths are configured to produce a temporal separation between each of the respective input signals.

7. The device element of claim 6, wherein the temporal separation is greater than a timing-jitter of the detector and less than an input temporal separation of the input signal.

8. The device element of claim 1, wherein the input waveguides are single-mode waveguides.

9. The device element of claim 1, wherein the input waveguides are multi-mode waveguides.

10. The device element of claim 1, wherein a core diameter of the output waveguide is greater than or equal to a core diameter of each of the input waveguides.

11. The device element of claim 1, wherein the receiver is configured to receive optical signals.

12. The device element of claim 11, wherein the input signal is distributed across a first number of spatial modes; the output signal is distributed across a second number of spatial modes; and a sum of the first number of spatial modes is less than the second number of spatial modes.

13. The device element of claim 11, wherein the detector is a single-photon detector.

14. The device element of claim 1, wherein the input and output waveguides are one or more selected from the range of:
one or more fibres; and
one or more waveguides.

15. A method for routing a plurality of signals to a detector, the method comprising:
receiving, at a receiver, a quantum input signal;
probabilistically determining, by a state discrimination device element of the receiver, the quantum states of the quantum input signal;
outputting, by the receiver, input signals corresponding to the quantum states of the quantum input signal;
converting, using a coupling device coupled to the receiver, the input signals to an output signal by time-division multiplexing the input signals; and
receiving, at a detector coupled to the coupling device, the output signal from the coupling device.

16. The method of claim 15, wherein the plurality of signals are coupled to the output fibre by applying a delay to each of the input signals at each of the corresponding input fibres, wherein each delay is unique.

17. The method of claim 16, wherein the delay is implemented by a fibre length of each of the plurality of input fibres.
